(19) United States
(12) Patent Application Publication
(10) Pub. No.: US 2004/0019801 A1
(43) Pub. Date: Jan. 29, 2004

(54) Secure content sharing in digital rights management

(76) Inventors: Fredrik Lindholm, Alvsjo (SE); Elisabetta Carrara, Sollentuna (SE); Bjorn Jonsson, Saltsjobaden (SE); Per-Olof Nerbrant, Osterskar (SE)

Correspondence Address: ERICSSON INC., 6300 LEGACY DRIVE, M/S EVW 2-C-2, PLANO, TX, 75024, US

(21) Appl. No.: 10/438,453

(22) Filed: May 14, 2003

Related U.S. Application Data
(60) Provisional application No. 60/381,425, filed on May 17, 2002.

(51) Int. Cl. H04L 9/00

(52) U.S. Cl. 713/200

(57) ABSTRACT

Method and system for securely sharing content in real-time systems over heterogeneous networks. Cryptographic mechanisms of the content are used to protect the confidentiality and the integrity of the content. The confidentiality/integrity protection may be performed either before storing the content on the content server (i.e., pre-encryption), or by the content server while the content is being sent (i.e., real-time encryption).

### CROSS-REFERENCE TO RELATED APPLICATION

This application for patent claims the benefit of priority from, and hereby incorporates by reference, U.S. Provisional Patent Application Serial No. 60/381,425 entitled “SECURE CONTENT SHARING—PERSONAL DRM” filed with the U.S. Patent and Trademark Office on May 17, 2002.

### BACKGROUND OF THE INVENTION

1. Field of the Invention

The present invention relates to the sharing and distribution of digital content and, in particular, to a method and system for securely sharing digital content in a digital rights management (DRM) system.

2. Description of the Related Art

Digital content (hereinafter “content”), such as audio, video, text, data, multimedia files and the like, can be easily and often illicitly shared or distributed, usually over a computer network. As a result, DRM technology was developed to restrict the sharing or distribution of the content. For example, content that is protected by DRM technology can be limited with respect to file access (e.g., number of views, length of views), altering, sharing, copying, printing, and saving. DRM restrictions are typically implemented in two ways. First is “containment,” where the content is encrypted so that only an authorized user can access it. Second is “marking,” where a watermark, flag, or an XrML tag is placed on the content as a signal to a terminal that the content is copy protected. These restrictions may be implemented within the operating system, software program, or in the actual hardware of a terminal.

Such restrictions, however, can make it difficult for the owners of the DRM content to share the content. This is because DRM restrictions are typically implemented on a terminal specific basis, that is, the DRM content is authorized to and accessible by one particular terminal. If the user tries to transfer or forward the content to another terminal, the new terminal will be unable to play/view the content. Thus, the user cannot share or distribute (at least not easily) his own content or content that he has purchased. To the extent that some DRM systems do allow sharing or distribution of DRM content, the content must be shared using the method imposed by the DRM system. This restriction limits the ability of the content purchaser to select the sharing or distribution method.

There are generally two methods of sharing and distributing content, as can be seen in FIG. 1. Both methods begin with the parties establishing communication with one another in step 100. The communication is typically established using some type of secure connection. Thereafter, party A decides to share her content with party B. In the first approach, party A shares her content by sending a pointer to the content to party B at step 102. The content itself is typically stored on party A's personal content server 10, of which party A and party B are clients, but to which only party A has authorized access normally (i.e., only party A can download content to the server). Party B then uses the pointer received from party A to send a request to the content server 10 at step 104. At step 106, the content server locates the content specified by the content pointer and sends the content to party B. In this way, party B is able to obtain party A's content.

In the second approach, instead of party A sending the pointer to party B at step 102, party A instructs the content server 10 regarding which content is to be shared and with whom at step 108. In this approach, party A and party B typically have arrived at some understanding or agreement beforehand regarding sharing of the content. The content sever 10 can then be used to “push” party A's content to party B.

In both of the approaches shown in FIG. 1, party A and party B are peers who can communicate with one another through their respective personal communication terminals 12 and 14, such as a mobile phone, a personal digital assistant, and the like. The communication between party A, party B, and the content server may be carried on a wireless link, a wired link, or a combination of both (e.g., one user is on a wireless link while the other user is on a wired link). Also, both party A and party B can be connected to one or more other content servers and other parties in addition to those shown in FIG. 1.

The increased use and distribution of content has placed increasingly greater demands on DRM and other similar systems. For example, there is no general security architecture for sharing content in real-time systems over arbitrary or heterogeneous networks (i.e., networks involving computers with disparate software and/or hardware). Present security architectures only provide the owner of the content with access control, which is the ability to give different users/clients different levels of access to the content. A full security solution, however, should include more than just access control. Confidentiality of the parties involved and integrity protection of the content are also needed. Such security measure, however, are difficult to implement in content sharing applications that are used in real-time systems over arbitrary networks. The problem is compounded when the content is DRM content and, therefore, must be shared or distributed in the method imposed by the DRM system.

Accordingly, it would be desirable to provide a general security architecture that can be applied to content sharing applications used in real-time systems over arbitrary networks. More particularly, it would be desirable to provide a secure method and system for sharing DRM content in real-time systems over arbitrary networks.

### SUMMARY OF THE INVENTION

The present invention is directed to a method and system for securely sharing content in real-time systems over arbitrary networks. The invention uses cryptographic techniques on the content to protect the confidentiality and integrity of the content shared between the parties involved. The confidentiality/integrity protection is independent of any of the underlying networks and may be performed either before storing the content on the content server (i.e., pre-encryption), or by the content server while the content is being sent (i.e., real-time encryption). Real-time encryption may be most suitable for real-time content, DRM content that may be manipulated by the content server, and content that cannot be pre-encrypted for some other reason. Pre-encryption may be most suitable for all other types of content, such as movies and music. In this way, the desired level of security, including access control, confidentiality, and integrity protection may be provided for real-time systems over arbitrary networks.

In general, in one aspect, the invention is directed to a method for sharing content between a first party and a second party in a secure communication session. The method comprises storing a content of the first party on a personal content server and distributing access information for the content from the first party to the second party, the access information allowing the second party to access the content. The method further comprises presenting the access information of the second party to the personal content server, verifying the access information from the second party in the personal content server, and processing the content for distribution to the second party upon verification of the access information.

In general, in another aspect, the invention is directed to a telecommunication system wherein content may be shared between a first party and a second party in a secure manner. The system comprises a first party terminal connected to a second party terminal in a secure communication session, the first party terminal configured to distribute access information for a content to the second party, the access information allowing the second party to access the content. The system further comprises a personal content server connected to the first and second party terminals and storing a content of the first party thereon, the personal content server configured to verify the access information when it is presented to the personal content server by the second party, and to process the content for distribution to the second party upon verification of the access information.

In general, in yet another aspect, the invention is directed to a network node for facilitating secure sharing of content between a first party and a second party. The network node normally accessible by the first party only, and comprising means for establishing a secure connection to the terminals of the first and second parties, means for storing a content of the first party, and means for issuing access authorization to the second party terminal. The network node further comprises means for receiving a request to access the content using the access authorization from the second party terminal, means for verifying the received access authorization, and means for distributing the content in a secure manner to the second party terminal upon verification of the access authorization.

It should be emphasized that the term comprises/comprising, when used in this specification, is taken to specify the presence of stated features, integers, steps, or components, but does not preclude the presence or addition of one or more other features, integers, steps, components, or groups thereof.

### BRIEF DESCRIPTION OF THE DRAWINGS

A better understanding of the invention may be had by reference to the following detailed description when taken in conjunction with the accompanying drawings, wherein:

FIG. 1 illustrates an example of an existing content sharing/distribution model;

FIG. 2 illustrates an exemplary content sharing/distribution model according to embodiments of the invention;

FIG. 3 illustrates another exemplary content sharing/distribution model according to embodiments of the invention;

FIG. 4 illustrates an exemplary DRM content sharing/distribution model according to embodiments of the invention;

FIG. 5 illustrates a flowchart for an exemplary implementation for a DRM module according to embodiments of the invention,

FIG. 6 illustrates a flowchart for another exemplary implementation of a DRM module according to embodiments of the invention; and

FIG. 7 illustrates a flowchart for an exemplary DRM content manipulation procedure according to embodiments of the invention.

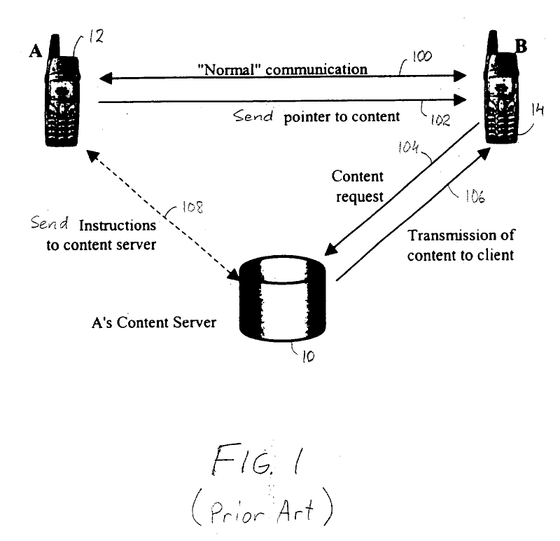

### DETAILED DESCRIPTION OF THE INVENTION

Following is a detailed description of the invention with reference to the drawings wherein reference numerals for the same and similar elements are carried forward.

As mentioned above, embodiments of the invention provide a secure method and system for sharing content. The present invention uses cryptographic mechanisms to protect the confidentiality and the integrity of the content. The cryptography should be independent of the underlying network and robust enough to handle a wide variety of connections, including low speed connections with high error rates (e.g., dial-up connections). An example of such a cryptographic mechanism is the Secure Real-time Transport Protocol (SRTP), which can provide both confidentiality protection of the user data and integrity protection on a per packet basis. Depending on the specifics of the application, either pre-encryption or real-time encryption may be used. The latter approach is especially useful where the content owner can use a trusted server (e.g., her own server, which is located at home or at her office). In that case, the owner has complete confidence in the server and does not have to worry about confidentiality or integrity. Thus, she may not want to, or simply cannot for some other reason, have the content pre-encrypted on the server. Therefore, in accordance with embodiments of the invention, the content server encrypts the content “on-the-fly” as it is being sent to a user.

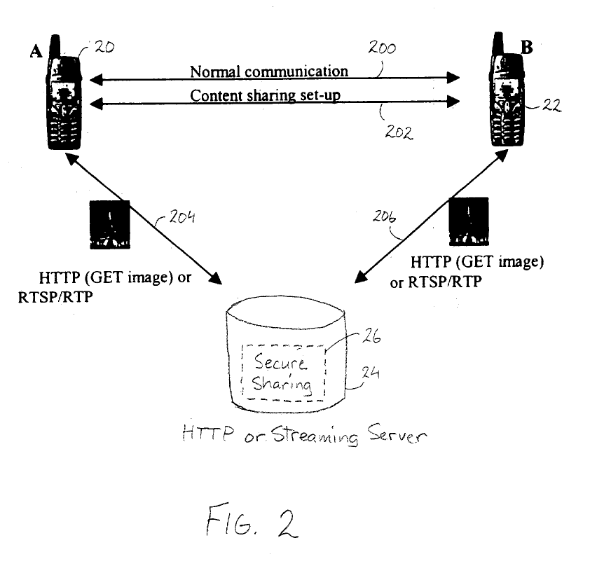

The “on-the-fly” encryption approach is illustrated in FIG. 2, where two or more parties are connected together. As before, the parties may be connected through their personal communication terminals 20 and 22 via a wireless and/or a wired link. Party A is the content owner, and party B represents one or more other parties who are interested in obtaining party A's content. The parties are also connected to the party A's personal content server 24, to which only party A has authorized access normally. The personal content server 24 of party A, however, is able to accept a request for rendering of specified contents by other parties capable of presenting access rights such as a ticket. In accordance with embodiments of the invention, the personal content sever includes a secure sharing function 26 that is capable of issuing access authorization (e.g., in the form of “tickets”), verifying the access authorization, as well as encrypting the content “on-the-fly”.

The first step in this approach is for the parties to establish a communication between them in step 200. The communication is again preferably carried on a secure connection. For example, a session key may be used to establish a secure connection between the parties. During the course of the communication, the parties agree to a sharing of party A's content (e.g., some pictures or a small video clip) with the other parties. Party A thereafter sends the location of the content, the security parameters, and any additional information that may be needed for security purposes to party B in step 202. The location of the content may be, for example, an HTTP, an FTP or an RTSP (Real-time Streaming Protocol) URL address. The security parameters may be sent in the form of a “ticket” or other key management protocols known to those having ordinary skill in the art, such as MIKEY (Multimedia Internet KEYing). MIKEY is a key management protocol designed to transport keys and other security parameters for different security protocols. “Tickets” are essentially electronic tokens, usually granted to authorize access to a specific resource under certain restrictions (e.g., during a certain time period or for a specific number of times).

Once the location and security information have been sent, the parties, including the content owner, initiate a secure download/streaming (e.g., using RTSP/RTP (Real-time Transport Protocol)) from the content server. This may be done in two different ways. The first approach is for party A to initiate the entire download/streaming session by sending the session information, including a key management message, to the content server 24 in step 204. The key management message includes keys that would be used by the secure sharing function 26 of the content server 24 to encrypt and protect the specific content. The content server 24 then encrypts the content and “pushes” the encrypted content to the involved parties at step 206. The encrypted content may be simultaneously pushed to multiple parties, for example, where party A has directed the content server to multicast to the parties. Party A also sends the session information to the other involved parties (step 202), including the key management message, using a key management protocol such as MIKEY. The other parties then use the keys in the key management message to decrypt the encrypted content received from the content server 24.

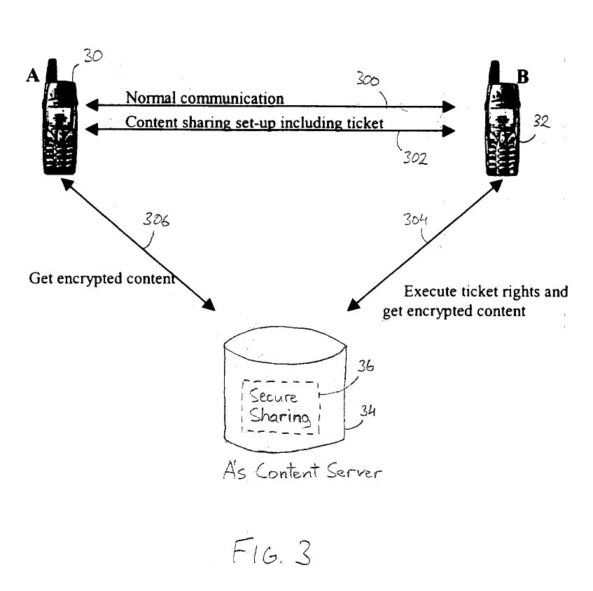

The second approach, illustrated in FIG. 3, is to use a “ticket” approach, where each communicating party receives a “ticket” that can be shown to the content server 24. In this approach, normal communication between the parties is again established at step 300 via their respective terminals 30 and 32 using a secure connection. At step 302, the parties again agree to a sharing of party A's content, which is stored on party A's personal content server 34. In accordance with embodiments of the invention, the content server 34 includes a secure sharing function 36 that is similar to the secure sharing function 26 in the previous figure (i.e., one that is capable of issuing access authorization, verifying the access authorization, and encrypting the content while it is being distributed). Party A thereafter sends a “ticket” to party B that contains information about the content as well as security parameters. The security parameters include keys that are used by the content server to encrypt party A's content. Party B thereafter presents its ticket to the content server 34. If the secure sharing function 36 the content server 34 can validate the ticket, the encrypted content is distributed to the holders of the ticket at step 304 (using security mechanisms described in the ticket). Some key management protocols, for example, the MIKEY protocol, can with small modifications be used as a “ticket.”

Note that party A may also request and receive the encrypted content at step 306. One reason for this is party A may have originally downloaded the content to her personal content server 34 in encrypted form. Thus, for party A to access the content, she would need a ticket from the content provider allowing access to the content. By presenting the ticket to the content server, party A is able to obtain and view the content in parallel with party B, which allows the two parties to discuss the content together.

In another aspect of the second approach, the ticket includes only part of a content key such as a nonce. According to this aspect, all parties share a common public function ƒ which can be used to derive a content key Cₖ, where Cₖ=ƒ(session key, nonce), and the session key is available only during an ongoing session. In this way, the ticket is made valid only during an ongoing session and cannot be used to obtain access to the contents in a later session.

As for the pre-encryption (and/or pre-integrity protected) approach, this approach is similar to the “on-the-fly” approach illustrated in FIG. 2. The main difference is that the content is encrypted before it is placed on the content server 10 so that whatever content is stored on the content server is already encrypted. This pre-encryption relieves the burden on party A of having to use a trusted or secure content server. Instead, party A may place its encrypted content on any available server. The encryption keys may then be distributed by party A over the secure connection (step 202) to the other involved parties along with location information for the content and security parameters. The other involved parties may thereafter use the encryption keys to access and decrypt the content on the content server. This approach has the advantage of requiring almost no additional functionality on the content server, such as encryption functionality, relative to the “on-the-fly” approach.

The foregoing embodiments address the problem of content sharing/distribution in general. The sharing/distribution of DRM content, however, poses a somewhat different problem due to the terminal specific authorization of DRM technology. While some DRM systems provide a special feature for forwarding content that has been authorized for one terminal to another, typically the original terminal loses its authorization in the process so that only one terminal is enabled at any time for the particular DRM content. This problem of sharing DRM content in general has not been heretofore addressed. However, by extending the content sharing model of the present invention, the DRM content sharing problem can be solved.

The present invention solves the problem of sharing DRM content by letting the user's content server handle some of the traditional DRM functionality, such as local access and rights management control. The user's content server will also handle the main communication with the DRM content server. Thus, instead of buying DRM content for a specific terminal, a user can buy the DRM content for her personal content server. The personal content server can then re-distribute the DRM content to the user's other terminals. This will make it easier for the user to view the content on different DRM enabled terminals, and also to share the content with other users in a restricted and controlled manner.

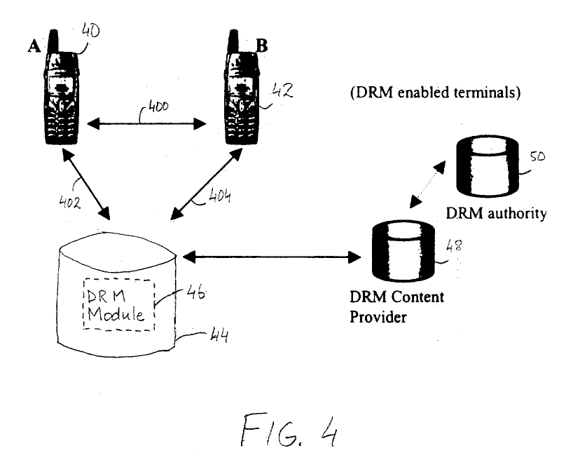

FIG. 4 illustrates a method of sharing/distributing DRM content according to embodiments of the invention. As can be seen, two or more parties are connected together, as before, through their personal communication terminals 40 and 42 via a wireless and/or a wired link. Party A is the party that has legally purchased one or more DRM content, and party B represents one or more other parties who are interested in obtaining party A's DRM content. The parties are also connected to party A's personal content server 44, which is a DRM content server, via the wireless and/or wired link. The terminals 40 and 42 and the personal content server 44 in FIG. 4 are slightly different from their counterparts in the previous figures in that they each contain a DRM module (only the DRM module 46 of the server 44 is shown here). The DRM module is the mechanism that either allows or prohibits playing/viewing of DRM protected content on a terminal according to whether the terminal was enabled for that content. Such DRM modules are known to those having ordinary skill in the art and may be implemented as software, hardware, or a combination of both.

In accordance with embodiments of the invention, the DRM module 46 of the personal content server 44 also allows it to perform certain traditional DRM functionality. For example, the personal content sever 20 is able to perform verification of access rights and to modify those access rights. Thus, the personal content sever 20 is able to verify party A's access rights and, where sharing is appropriate, transfer a certain amount of those access rights to a ticket that is distributed to party B for shared access to the content. In some embodiments, the personal content sever 20 is able to modify the content itself, for example, by reformatting the content, re-encrypting the content, and marking the content. The personal content sever 20 is also able to verify whether a DRM module exists in the terminals of each involved party and whether the modules, including the server's own DRM module, is valid and up to date.

A DRM content provider 48 is connected to the personal content server 44 and is responsible for storing and providing DRM protected content to legal purchasers of the content such as the personal content server 44. The DRM content provider 48 is, in turn, connected to a DRM authority 50. The DRM authority 50 handles the issuing of rights (i.e., the tickets) to specific DRM protected content for a purchaser and his terminal devices. The DRM authority 50 may also handle financial functions, such as the charging and billing of the purchaser. The DRM content provider 48 accepts tickets issued by the DRM authority 50, and also provides the content according to the rules set in the ticket.

As in previous embodiments, the first step in FIG. 4 is for the parties to establish a secure communication between them at step 400 using, for example, a session key. Then, when party A attempts to share a DRM protected content, party A's content server 44 first verifies at step 402 that the terminals of all involved parties, including party A's terminal, contains a valid DRM module, either as software or hardware. The personal content server 44 also has its own DRM module that it must verify. The personal content server 44 performs this verification by obtaining information (e.g., identification, status, etc.) regarding each DRM module and confirming with the DRM authority 50 whether the DRM module is valid. Since the DRM authority 50 is the entity that issues and revokes DRM modules, it is the entity that can properly authenticate a DRM module. Note that this arrangement requires some type of existing relationship (indicated by the dotted arrow) between the DRM content provider 48 and the DRM authority 50 (e.g., one may be owned by the other).

Once the personal content server 44 verifies that all involved parties have a valid DRM module, it verifies (again at step 402) that party A has the right to access and to share DRM content with other terminals. After this verification, the personal content server 44 obtains at step 404 the DRM protected content from the DRM content provider 48. Thereafter, each time one of the parties requests the DRM protected content, the personal content server 44 can reacquire the content from the DRM content provider 48, or it can store a copy of the content locally for subsequent access.

The right to access and to share DRM content can be very flexible. For example, the buyer can be allowed to share the entire content, parts of the content, the entire content a specific number of times, and other similar arrangements. The content can then be distributed to the different parties using the approach described previously in FIGS. 2-3. The particular method used will depend on whether party A's personal content server 44 has the right to manipulate the content or it if is only allowed to forward the content. Where the personal content server 44 includes only a DRM module 46 that does not allow to manipulation of the content from the DRM content provider 48. In that case, the personal content server 44 will distribute the content in a manner very similar to the pre-encrypted distribution model discussed above.

If, on the other hand, the personal content server 44 includes a DRM module 46 that allows manipulation of the DRM content, then a different approach may be used. For example, the DRM module may be used to re-encrypt, watermark, and re-format the DRM content in a secure way so that the content fits the terminals that it is sent. The distribution principle used in this scenario is then very similar to the “on-the-fly” distribution model discussed earlier. In some embodiments, it is possible for the DRM module in the terminal of party A to issue the encryption key for the content. That key will then be used to re-encrypt the content in the manipulation process of the personal content server 44. The same key is distributed to the other involved parties.

In some embodiments, the personal content server's DRM module 46 can create a software DRM module for transfer and download into a terminal. In this way, the personal content server's DRM module and the terminal located DRM modules may be made to match one another. Furthermore, the server and terminal implemented DRM modules may contain a function f that can be used to derive a content key Cₖ and an address to the content server. The derivation may use a nonce and a session identity, as described in above with respect to the “ticket” approach.

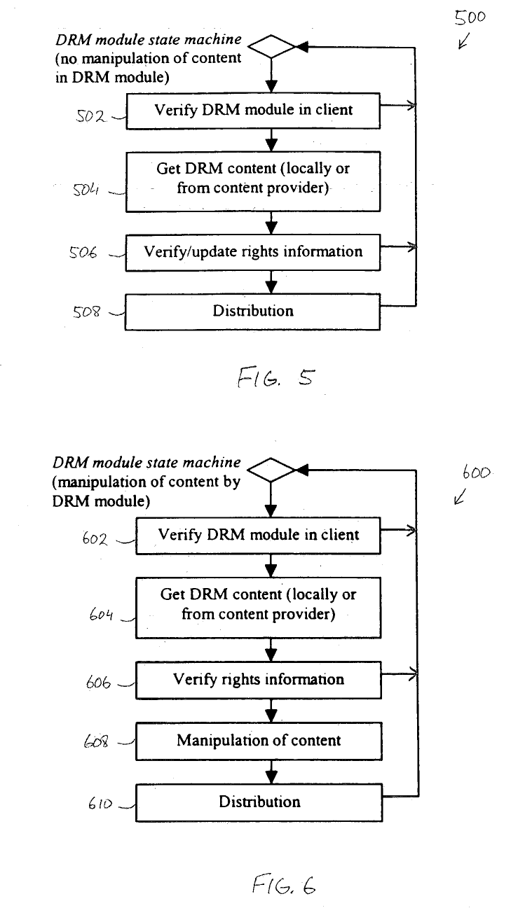

FIG. 5 illustrates a flow diagram 500 that represents one exemplary implementation of a DRM module in the personal content server where no manipulation of content is allowed. As can be seen, the first thing that the server DRM module does is verify that the client or terminal DRM modules are valid at step 502. This verification can be done, for example, via the DRM authority described above. If the verification fails (i.e., one or more of the terminal DRM modules are invalid), then the server DRM module returns to the beginning of the flow diagram. Otherwise, at step 504, the server DRM module obtains the desired DRM protected content, either from a DRM content provider or from a locally stored copy of the content. The server DRM module thereafter verifies that the purchasing party has distribution rights at step 506. It may be that the purchasing party only recently purchased the distribution rights, in which case the server DRM module also update that party's rights information. Thereafter, the server DRM module continues to the distribution stage of the procedure at step 508. On the other hand, if the purchasing party has no distribution rights, then from step 506, the server DRM module returns to the beginning of the procedure.

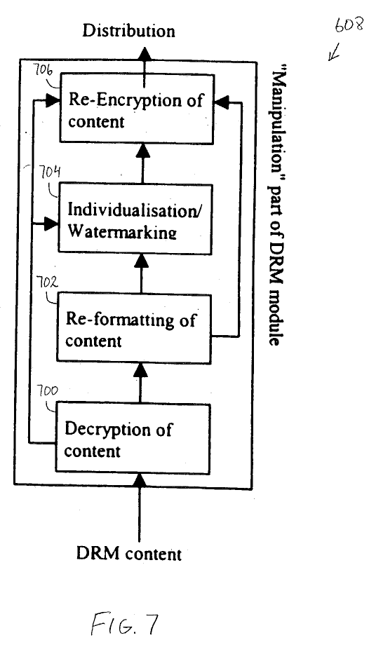

FIG. 6 illustrates a flow diagram 600 that represents one exemplary implementation of a DRM module in the personal content sever where manipulation of the content is allowed. The flow diagram 600 has essentially the same first three steps as the flow diagram 500, namely, verification of the terminal DRM modules (step 602), acquisition of the DRM protected content (step 604), and verification of distribution rights (step 606). At step 608, however, the server DRM module is allowed to manipulate the DRM protected content, as will be described further below. After manipulation, the server DRM module continues to the distribution stage of the procedure at step 610.

FIG. 7 illustrates a flow diagram 700 that represents one exemplary implementation of the manipulation process (step 608). As can be seen, in some embodiments, manipulation begins with decryption of the DRM content at step 700 using the encryption key that was provided by the DRM content provider upon purchase of the DRM content. At step 702, reformatting of the content takes place if necessary for the terminal of the purchasing party or any of the involved parties to be able to use the content. After reformatting, the content is tagged or individualized with a watermark at step 704 in accordance with conventional DRM technology. The content is then re-encrypted at step 706 using either the same encryption key as before, or a separate key for some or all of the parties receiving the content. On the other hand, if no reformatting of the content is needed, then the DRM content is simply re-encrypted at step 706 without individualization at step 704.

While particular embodiments and applications of the present invention have been illustrated and described, it is to be understood that the invention is not limited to the precise construction and compositions disclosed herein, and that modifications and variations may be made to the foregoing without departing from the scope of the invention as defined in the appended claims.

What is claimed is:

1. A method for sharing content between a first party and a second party in a secure communication session, comprising:
storing a content of the first party on a personal content server;
distributing access information for the content from the first party to the second party, the access information allowing the second party to access the content;
presenting the access information of the second party to the personal content server;
verifying the access information from the second party in the personal content server; and
processing the content for distribution to the second party upon verification of the access information.

2. The method according to claim 1, wherein the content comprises a streamed content, including a RTSP/RTP streamed content, and the step of processing comprises encrypting the content while it is being streamed.

3. The method according to claim 2, wherein the content may be accessed by using a ticket.

4. The method according to claim 2, wherein the streamed content is DRM protected content.

5. The method according to claim 4, wherein the personal content server is capable of manipulating the DRM content for the second party, further comprising the steps of:
authenticating a DRM module in a terminal of the second party;
confirming a right of the first party to distribute the DRM content;
manipulating the DRM content, if needed, to match the terminal of the second party; and
creating a right specifically for the second party to access the manipulated content.

6. The method according to claim 5, wherein the step of manipulating comprises
decrypting the DRM content;
reformatting the DRM content, if needed, to match the terminal of the second party;
tagging the DRM content for the terminal of the second party; and
re-encrypting the content with a specific key for the second party.

7. The method according to claim 4, wherein the personal content server has a pre-installed first DRM module and wherein the step of distributing comprises the steps of:
generating a second DRM module in the personal content server; and
distributing the second DRM module from the personal content server to the second party.

8. The method according to claim 1, wherein the personal content server and each terminal of the parties share a predetermined function, further comprising the step of:
distributing a nonce from the personal content server to the terminals; and
deriving a content key in the terminals and the personal content server based on the predetermined function, the nonce, and a session identity.

9. The method according to claim 1, wherein the content is encrypted prior to being stored on the personal content server.

10. A telecommunication system wherein content may be shared between a first party and a second party in a secure manner, comprising:
a first party terminal;
a second party terminal connected to the first party terminal in a secure communication session, the first party terminal configured to distribute access information for a content to the second party, the access information allowing the second party to access the content;
a personal content server connected to the first and second party terminals and storing a content of the first party thereon, the personal content server configured to verify the access information when it is presented to the personal content server by the second party, and to process the content for distribution to the second party upon verification of the access information.

11. The telecommunication system according to claim 10, wherein the content comprises a streamed content, including a RTSP/RTP streamed content, and the personal content server processes the content by encrypting the content while it is being streamed.

12. The telecommunication system according to claim 11, wherein the content may be accessed by using a ticket.

13. The telecommunication system according to claim 11, wherein the streamed content is DRM protected content.

14. The telecommunication system according to claim 13, wherein the personal content server is further configured to authenticate a DRM module in the second party terminal, confirm a right of the first party terminal to distribute the DRM content, manipulate the DRM content, if needed, to match the second party terminal, and create a right specifically for the second party terminal to access the manipulated content.

15. The telecommunication system according to claim 14, wherein the personal content server manipulates the content by decrypting the DRM content, reformatting the DRM content, if needed, to match the second party terminal, tagging the DRM content for the second party terminal, and re-encrypting the content with a specific key for the second party terminal.

16. The telecommunication system according to claim 13, wherein the personal content server has a pre-installed first DRM module and is further configured to generate a second DRM module, and to distribute the second DRM module to the second party terminal.

17. The telecommunication system according to claim 10, wherein the personal content server and first and second party terminals share a predetermined function and the personal content server is configured to distribute a nonce to the terminals, and both the personal content server and the terminals are configured to derive a content key based on the predetermined function, the nonce, and a session identity.

18. The telecommunication system according to claim 10, wherein the content is encrypted prior to storage on the personal content server.

19. A network node for facilitating secure sharing of content between a first party and a second party, said network node normally accessible by the first party only, comprising:
means for establishing a secure connection to the terminals of the first and second parties;
means for storing a content of the first party;
means for issuing access authorization to the second party terminal;
means for receiving a request to access the content using the access authorization from the second party terminal;
means for verifying the received access authorization; and
means for distributing the content in a secure manner to the second party terminal upon verification of the access authorization.

20. The network node according to claim 19, wherein the content comprises a streamed content, including a RTSP/RTP streamed content, and the personal content server processes the content by encrypting the content while it is being streamed.

21. The network node according to claim 20, wherein the content may be accessed by using a ticket.

22. The network node according to claim 20, wherein the streamed content is DRM protected content.

23. The network node according to claim 22, further comprising means for authenticating a DRM module in the second party terminal, confirming a right of the first party terminal to distribute the DRM content, manipulating the DRM content, if needed, to match the second party terminal, and creating a right specifically for the second party terminal to access the manipulated content.

24. The network node according to claim 23, wherein the means for manipulating includes means for decrypting the DRM content, reformatting the DRM content, if needed, to match the second party terminal, tagging the DRM content for the second party terminal, and re-encrypting the content with a specific key for the second party terminal.

25. The network node according to claim 22, further comprising means for generating a DRM module, and distributing the DRM module to the second party terminal.

26. The network node according to claim 19, wherein the network node and the first and second party terminals share a predetermined function, further comprising means for distributing a nonce to the terminals, and for deriving a content key based on the predetermined function, the nonce, and a session identity.

27. The network node according to claim 19, wherein the content is encrypted prior to storing.
